(19) United States
(12) Patent Application Publication
(10) Pub. No.: US 2023/0328816 A1
(43) Pub. Date: Oct. 12, 2023

(54) BASE STATION AND COMMUNICATION METHOD

(71) Applicant: NIPPON TELEGRAPH AND TELEPHONE CORPORATION, Tokyo (JP)

(72) Inventors: Yasuhiko INOUE, Musashino-shi, Tokyo (JP); Kengo NAGATA, Musashino-shi, Tokyo (JP); Akira KISHIDA, Musashino-shi, Tokyo (JP); Yasushi TAKATORI, Musashino-shi, Tokyo (JP); Yusuke ASAI, Musashino-shi, Tokyo (JP)

(73) Assignee: NIPPON TELEGRAPH AND TELEPHONE CORPORATION, Tokyo (JP)

(21) Appl. No.: 18/017,658

(22) PCT Filed: Jul. 27, 2020
(86) PCT No.: PCT/JP2020/028677

§ 371 Date: Jan. 23, 2023

(51) Int. Cl. H04W 76/15; H04W 74/08

(52) U.S. Cl. CPC H04W 76/15; H04W 74/0808

(57) ABSTRACT

A base station (10) according to one aspect of the present invention includes a plurality of radio signal processing units (130, 140, and 150), a carrier sense control unit (160), and a management unit (120). The plurality of radio signal processing units (130, 140, and 150) transmit and receive radio signals of different channels. The carrier sense control unit (160) executes collective carrier sensing on a channel of each of the plurality of radio signal processing units (130, 140, and 150) using an access parameter common to the plurality of radio signal processing units (130, 140, and 150) and determines whether the channel is in an idle state or busy state. The management unit (120) performs processing for transmitting radio signals by a multi-link wirelessly connected through a plurality of types of channels when there are a plurality of links formed between a radio signal processing unit having the channel determined to be in an idle state and a terminal (20).

### TECHNICAL FIELD

The present invention relates to a wireless communication technology.

### BACKGROUND ART

A wireless local area network (LAN) is known as a wireless system for wirelessly connecting a base station and a terminal. In recent years, a plurality of frequency bands have become available for wireless LAN devices.

### CITATION LIST

### Non Patent Literature

[Non Patent Literature 1] IEEE Std 802.11-2016, “FIGS. 4-25 Establishing the IEEE 802.11 association” and “11.3 STA authentication and association,” 7 Dec. 2016

### SUMMARY OF INVENTION

### Technical Problem

Since data is normally transmitted and received by designating one frequency band, other frequency bands are not used at the same time and the frequency band is not effectively used even if other frequency bands are available.

### Solution to Problem

A base station according to an embodiment of the present invention includes a plurality of radio signal processing units, a carrier sense control unit, and a management unit. The plurality of radio signal processing units transmit and receive radio signals of different channels. The carrier sense control unit executes collective carrier sensing on a channel of each of the plurality of radio signal processing units using an access parameter common to the plurality of radio signal processing units, and determines whether the channel is in an idle state or a busy state. When there are a plurality of links formed between a radio signal processing unit having the channel determined to be in an idle state and a terminal, the management unit performs processing for transmitting radio signals by a multi-link wirelessly connected through a plurality of types of channels.

### Advantageous Effects of Invention

According to one aspect of the present invention, throughput can be improved.

### BRIEF DESCRIPTION OF DRAWINGS

FIG. 1 is a diagram illustrating a wireless system according to the present embodiment.

FIG. 2 is a block diagram illustrating an example of a hardware configuration of a base station according to the present embodiment.

FIG. 3 is a block diagram illustrating an example of a functional configuration of the base station according to the present embodiment.

FIG. 4 is a block diagram illustrating an example of a functional configuration of a radio signal processing unit of the base station according to the present embodiment.

FIG. 5 is a block diagram illustrating an example of a hardware configuration of a terminal according to the present embodiment.

FIG. 6 is a block diagram illustrating an example of a functional configuration of the terminal according to the present embodiment.

FIG. 7 is a diagram illustrating processing at a media access control (MAC) layer in communication between the base station and the terminal.

FIG. 8 is a flowchart illustrating an example of a downlink operation of the base station according to the present embodiment.

FIG. 9 is a flowchart illustrating carrier sense control processing of a carrier sense control unit according to the present embodiment.

FIG. 10 is a conceptual diagram illustrating an example of a link used for transmission selected through carrier sense control processing shown in FIG. 9.

FIG. 11 is a conceptual diagram illustrating an example of allocation of transmission data to a link by a link management unit.

### DESCRIPTION OF EMBODIMENTS

Hereinafter, embodiments of the present invention will be described with reference to the drawings.

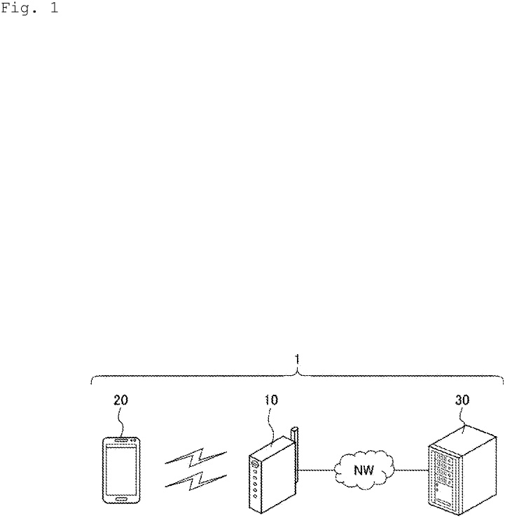

FIG. 1 illustrates an example of a configuration of a wireless system 1 according to the embodiment. As shown in FIG. 1, the wireless system 1 includes, for example, a base station 10, a terminal 20, and a server 30.

The base station 10 is connected to a network NW and is used as an access point of a wireless LAN. For example, the base station 10 can wirelessly transmit data received from the network NW to the terminal 20. Also, the base station 10 can be connected to the terminal 20 using one type of band or a plurality of types of bands. Although “multi-link” refers to wireless connection using a plurality of types of frequency bands (for example, 2.4 GHz band and 5 GHz band) between the base station 10 and the terminal 20 in the present embodiment, the present invention is not limited thereto and “multi-link” may refer to wireless connection using a plurality of types of channels in the same frequency band (for example, different channels in 5 GHz band). Communication between the base station 10 and the terminal 20 is based on, for example, the IEEE 802.11 standard.

The terminal 20 is, for example, a wireless terminal such as a smartphone or a tablet PC. The terminal 20 can transmit/receive data to/from the server 30 on the network NW via the base station 10, which is connected wirelessly. Note that the terminal 20 may be another electronic device such as a desktop computer or a laptop computer. The terminal 20 need only be a device that can communicate with at least the base station 10 and can execute later-described operations.

The server 30 can hold various types of information, and for example, holds content data for the terminal 20. The server 30 is connected to, for example, the network NW by wire, and is configured to be able to communicate with the base station 10 via the network NW. Note that the server 30 need only be able to communicate with at least the base station 10. That is, communication between the base station 10 and the server 30 may be in a wired or wireless manner.

Communication between the base station 10 and the terminal 20 is based on an open systems interconnection (OSI) reference model. Communication functions in the OSI reference model are divided into seven layers (Layer 1: physical layer (PHY layer), Layer 2: data link layer, Layer 3: network layer, Layer 4: transport layer, Layer 5: session layer, Layer 6: presentation layer, Layer 7: application layer).

The data link layer includes, for example, a logical link control (LLC) layer and a media access control (MAC) layer. The LLC layer adds a destination service access point (DSAP) header, a source service access point (SSAP) header, and the like to data input from a higher application, for example, to form LLC packets. The MAC layer adds an MAC header to the LLC packets, for example, to form MAC frames.

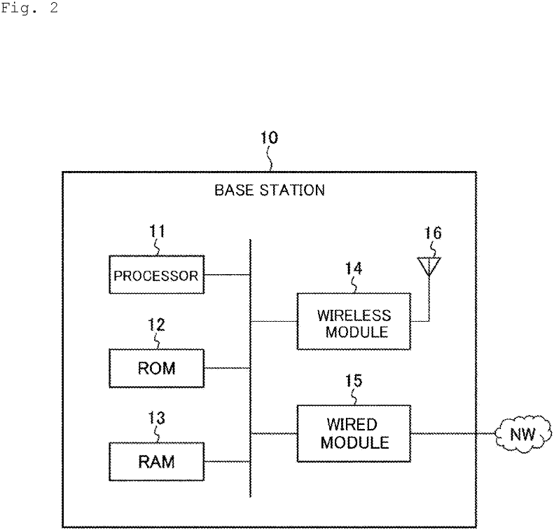

Subsequently, an example of a hardware configuration of the base station 10 according to the present embodiment will be described with reference to FIG. 2. The base station 10 includes a processor 11, a read only memory (ROM) 12, a random access memory (RAM) 13, a wireless module 14, and a wired module 15.

The processor 11 is a circuit capable of executing various programs and, for example, a central processing unit (CPU), a graphics processing unit (GPU), an application specific integrated circuit (ASIC) or a field programmable gate array (FPGA) may be conceived as the processor 11. The processor 11 controls the overall operation of the base station 10. The ROM 12 is a non-volatile semiconductor memory, and holds a program, control data, and the like for controlling the base station 10. The RAM 13 is a volatile semiconductor memory, for example, and is used as a work area for the processor 11. The wireless module 14 is a circuit used for transmitting and receiving data by radio signals, and is connected to an antenna. Further, the wireless module 14 includes, for example, a plurality of communication modules corresponding to each of a plurality of frequency bands. The wired module 15 is a circuit used for transmitting and receiving data by a wired signal and is connected to the network NW.

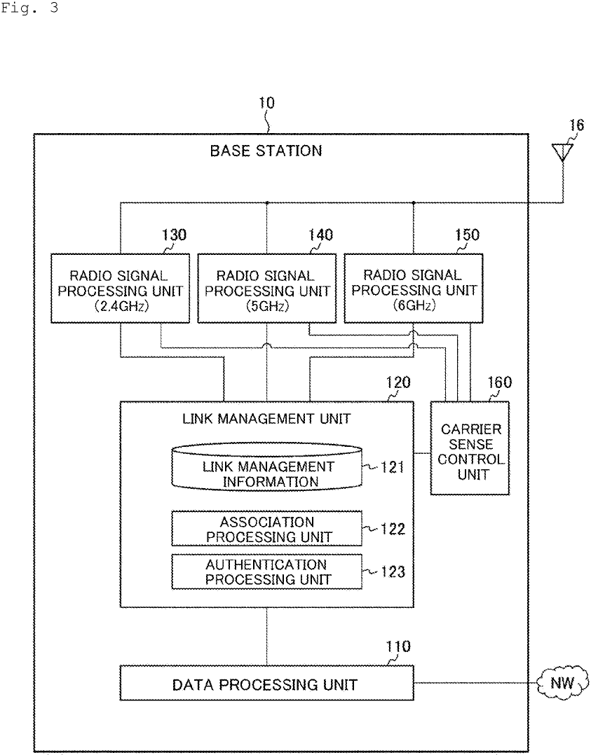

Next, an example of a functional configuration of the base station 10 according to the present embodiment will be described with reference to the block diagram of FIG. 3.

The base station 10 includes a data processing unit 110, a link management unit 120, a radio signal processing unit 130, a radio signal processing unit 140, a radio signal processing unit 150, and a carrier sense control unit 160. Further, the link management unit 120 includes an association processing unit 122 and an authentication processing unit 123. Processing of the data processing unit 110, the link management unit 120, the radio signal processing unit 130, the radio signal processing unit 140, the radio signal processing unit 150, and the carrier sense control unit 160 is realized by the processor 11 and the wireless module 14, for example.

The data processing unit 110 can execute processing of the LLC layer and processing of upper layers (the third to seventh layers) on input data. For example, the data processing unit 110 outputs data input from the server 30 via the network NW to the link management unit 120. Further, the data processing unit 110 transmits data input from the link management unit 120 to the server 30 via the network NW. The data processing unit 110 may include a queue or may temporarily accumulate data to be transmitted and received.

The link management unit 120 executes, for example, a part of processing of the MAC layer on the input data. Also, the link management unit 120 manages the link with the terminal 20 based on notifications from the radio signal processing units 130, 140, and 150. The link management unit 120 sets a link formed between the terminal 20 and a radio communication processing unit having a channel determined to be in an idle state by the carrier sense control unit 160 which will be described later as a link used for transmission or reception. Particularly, when there are a plurality of links formed between terminal 20 and the radio communication processing unit having a channel determined to be in an idle state, processing for cooperative transmission of a radio signal by multi-link is performed. The link management unit 120 includes link management information 121. The link management information 121 is stored in, for example, the RAM 13, and includes information on the terminal 20 that is wirelessly connected to the base station 10, information on available links, and the like.

When the association processing unit 122 receives a connection request of the terminal 20 via one of the radio signal processing units 130, 140, and 150, the association processing unit 122 executes a protocol related to the association. The authentication processing unit 123 executes a protocol related to authentication following the connection request.

The radio signal processing units 130, 140 and 150 transmit and receive radio signals of different frequency bands between the base station 10 and the terminal 20. For example, each of the radio signal processing units 130, 140, and 150 creates a radio frame by adding a preamble, a PHY header, and the like to data input from the link management unit 120. Then, each of the radio signal processing units 130, 140, and 150 converts the radio frame into a radio signal and transmits the radio signal via an antenna 16 of the base station 10.

In addition, each of the radio signal processing units 130, 140, and 150 converts a radio signal received via the antenna 16 of the base station 10 into a radio frame. Then, each of the radio signal processing units 130, 140, and 150 outputs data included in the radio frame to the link management unit 120.

Each of the radio signal processing units 130, 140, and 150 can execute, for example, a part of processing of the MAC layer and processing of the PHY layer on input data or a radio signal. For example, the radio signal processing unit 130 handles radio signals in the 2.4 GHz band. The radio signal processing unit 140 handles radio signals in the 5 GHz band. The radio signal processing unit 150 handles radio signals in the 6 GHz band. The radio signal processing units 130, 140, and 150 may share an antenna 16 of the base station 10, or a dedicated antenna for each radio signal processing unit may be provided such that each radio signal processing unit can perform communication therethrough.

The carrier sense control unit 160 executes collective carrier sensing on frequency bands of the radio signal processing units 130, 140 and 150 by using an access parameter common to the radio signal processing units 130, 140 and 150. After executing carrier sensing, the carrier sense control unit 160 receives a carrier sense result (hereinafter referred to as carrier sense information) from each of the radio signal processing units 130, 140 and 150. Carrier sensing is processing for detecting a use state of a channel and is used determine whether the channel is in an idle state or a busy state. Carrier sensing may be performed using Clear Channel Assessment (CCA), for example. The carrier sense control unit determines a channel state according to Carrier Sense Multiple Access with Collision Avoidance (CSMA/CA) on the basis of carrier sense information. The carrier sense control unit 160 outputs link information on one or a plurality of links determined to be an idle channel to the link management unit 120 by determining channel states.

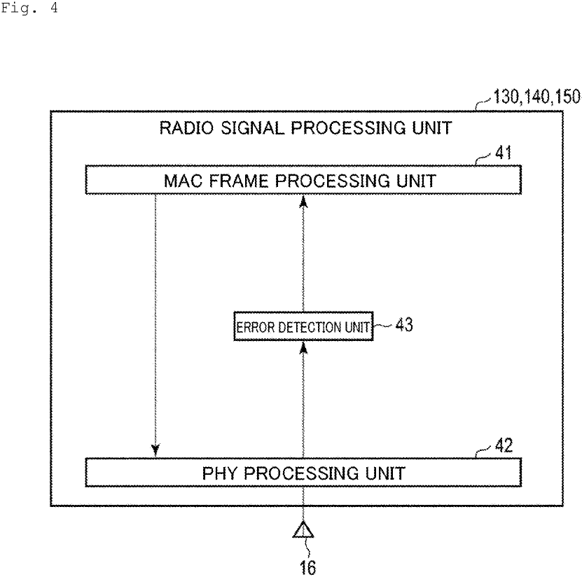

Next, an example of a functional configuration of the radio signal processing units of the base station 10 according to the present embodiment will be described with reference to the block diagram of FIG. 4.

The radio signal processing unit shown in FIG. 4 has a configuration common to the radio signal processing units 130, 140 and 150 shown in FIG. 3.

The radio signal processing unit includes a MAC frame processing unit 41, a PHY processing unit 42, and an error detection unit 43.

The MAC frame processing unit 41 receives data from the link management unit 120, generates a MAC frame on the basis of the data, and outputs the MAC frame to the PHY processing unit 42. Upon reception of data from the PHY processing unit 42, the MAC frame processing unit 41 extracts a MAC frame from the data, executes processing based on a header of the MAC frame, and outputs the processing result to the link management unit 120. Header-based processing may conform to operation of the general IEEE 802.11 standard. For example, the MAC frame processing unit 41 refers to the address field of the header, and outputs the MAC frame to the link management unit 120 if the MAC frame is addressed to the host station. At that time, the MAC frame is output to the link management unit 120 along with a sequence number indicating success/failure of reception of each MAC service data unit (MSDU), which is necessary for the link management unit 120 to generate Block ACK. On the other hand, if the MAC frame is not addressed to the host station, the MAC frame processing unit 41 discards the MAC frame.

The PHY processing unit 42 performs processing of the PHY layer with respect to wireless communication with the terminal 20. The MAC frame is received from the MAC frame processing unit 41, converted into a radio signal, and transmitted to the terminal 20. The PHY processing unit 42 receives the radio signal from the terminal 20, extracts the MAC frames from the radio signal, and outputs the MAC frames to the error detection unit 43. The PHY processing unit 42 measures information necessary to carry out carrier sensing to generate carrier sense information and outputs the carrier sense information to the link management unit 120. For example, the PHY processing unit 42 measures a received signal strength indicator (RSSI) and generates carrier sense information including the measured value of the RSSI. In addition, the PHY processing unit 42 broadcasts a beacon.

The error detection unit 43 detects errors in the MAC frame in order to determine whether or not the signal transmitted from the terminal 20 has been correctly received. Error detection is performed using FCS included in the MAC frame. Error detection may be performed in units of MPDUs. When it is determined that there is no error in the MAC frame, the error detection unit 43 outputs the MAC frame to the MAC frame processing unit 41. On the other hand, when there is an error in the MAC frame, the error detection unit 43 discards the MAC frame.

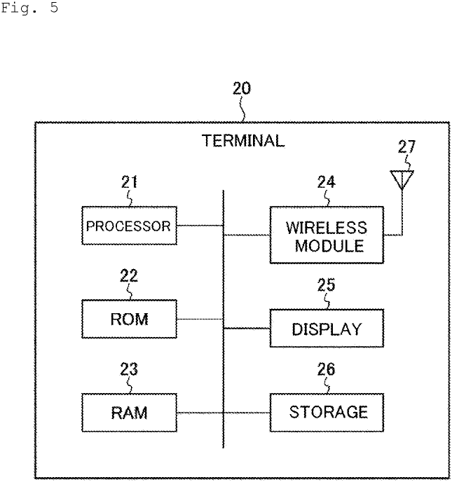

Next, an example of a hardware configuration of the terminal 20 according to the present embodiment will be described with reference to the block diagram of FIG. 5.

The terminal 20 includes a processor 21, a ROM 22, a RAM 23, a wireless module 24, a display 25, and a storage 26.

The processor 21 is a circuit capable of executing various programs like the processor 11 of the base station 10, and controls the overall operation of the terminal 20. The ROM 22 is a non-volatile semiconductor memory and holds a program, control data, and the like for controlling the terminal 20. The RAM 23 is a volatile semiconductor memory, for example, and is used as a work area for the processor 21. The wireless module 24 is a circuit used to transmit and receive data through radio signals and is connected to an antenna 27. Further, the wireless module 24 includes, for example, a plurality of communication modules corresponding to each of a plurality of frequency bands. The display 25 displays, for example, a graphical user interface (GPU) of an application, and the like. The display 25 may have a function of an input interface of the terminal 20. The storage 26 is a non-volatile storage device, and holds, for example, system software and the like of the terminal 20.

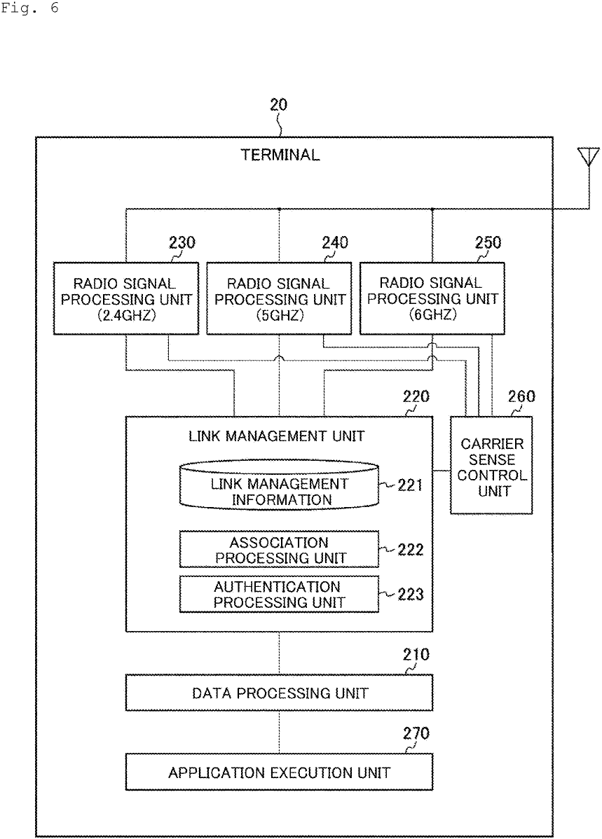

Next, an example of a functional configuration of the terminal 20 according to the present embodiment will be described with reference to the block diagram of FIG. 6. The terminal 20 serves as a data processing unit 210, a link management unit 220, a radio signal processing unit 230, a radio signal processing unit 240, a radio signal processing unit 250, a carrier sense control unit 260, and an application execution unit 270. Processing of the data processing unit 210, the link management unit 220, the radio signal processing unit 230, the radio signal processing unit 240, the radio signal processing unit 250, the carrier sense control unit 260, and the application execution unit 270 is realized by the processor 21 and the wireless module 24, for example.

The data processing unit 210 can execute processing of the LLC layer and processing of upper layers (the third to seventh layers) on input data. For example, the data processing unit 210 outputs the data input from the application execution unit 270 to the link management unit 220. Also, the data processing unit 210 outputs the data input from the link management unit 220 to the application execution unit 270.

The link management unit 220 executes, for example, a part of processing of the MAC layer on the input data. Further, the link management unit 220 manages a link with the base station 10 on the basis of notifications from the carrier sense control unit 260, the radio signal processing units 230, 240, and 250. The link management unit 220 generates a Block ACK on the basis of reception states of data (MSDU) received from the radio signal processing units. The link management unit 220 includes link management information 221. The link management information 221 is stored in, for example, the RAM 23, and includes information on the base station 10 wirelessly connected to the terminal 20. Also, the link management unit 220 includes an association processing unit 222 and an authentication processing unit 223. The association processing unit 222 executes a protocol related to association by transmitting a connection request to the base station 10 via any one of the radio signal processing units 230, 240, and 250. The authentication processing unit 223 executes a protocol related to authentication following the connection request.

Each of the radio signal processing units 230, 240, and 250 performs transmission and reception of data between the base station 10 and the terminal 20 using wireless communication. For example, each of the radio signal processing units 230, 240, and 250 creates a radio frame by adding a preamble, a PHY header, and the like to data input from the link management unit 220. Then, each of the radio signal processing units 230, 240, and 250 converts the radio frame into a radio signal and transmits the radio signal via an antenna of the terminal 20. In addition, each of the radio signal processing units 230, 240, and 250 converts a radio signal received via the antenna of the terminal 20 into a radio frame. Then, each of the radio signal processing units 230, 240, and 250 outputs data included in the radio frame and a sequence number related to success/failure of reception of each MSDU included in the received radio frame to the link management unit 220.

In this manner, each of the radio signal processing units 230, 240, and 250 can execute, for example, a part of processing of the MAC layer and processing of the PHY layer on the input data or radio signal. For example, the radio signal processing unit 230 handles radio signals in the 2.4 GHz band. The radio signal processing unit 240 handles radio signals in the 5 GHz band. The radio signal processing unit 250 handles radio signals in the 6 GHz band. The radio signal processing units 230, 240, and 250 may share the antenna of the terminal 20, or an antenna dedicated for each radio signal processing unit may be provided such that each radio signal processing unit can perform communication therethrough.

Similarly to the carrier sense control unit 160 of the base station 10, the carrier sense control unit 260 executes collective carrier sensing for frequency bands of the radio signal processing units 230, 240 and 250 using an access parameter common to the radio signal processing units 230, 240 and 250. The carrier sense control unit 260 receives carrier sense information from each of the radio signal processing units 230, 240, and 250 and determines channel states according to CSMA/CA. The carrier sense control unit 260 outputs link information on a link determined to be an idle channel to a link management unit 220 by determining channel states.

The application execution unit 270 executes an application that can use data input from the data processing unit 210. For example, the application execution unit 270 can display information on the application on the display 25. Further, the application execution unit 270 can operate based on operation of the input interface.

In the wireless system 1 according to the present embodiment, the radio signal processing units 130, 140, and 150 of the base station 10 are configured to be able to be respectively connected to the radio signal processing units 230, 240, and 250 of the terminal 20. That is, the radio signal processing units 130 and 230 can be wirelessly connected using the 2.4 GHz band. The radio signal processing units 140 and 240 can be wirelessly connected using the 5 GHz band. The radio signal processing units 150 and 250 can be wirelessly connected using the 6 GHz band. In the present application, each radio signal processing unit may be referred to as an “STA function”. That is, the wireless system 1 according to the embodiment includes a plurality of STA functions.

In the case where multi-link is performed on a plurality of channels having the same frequency band, the radio signal processing units 130, 140, and 150 may handle radio signals of different channels in the same frequency band. For example, the radio signal processing units 130 and 230 may be wirelessly connected using a first channel in the 2.4 GHz band,the radio signal processing units 140 and 240 may be wirelessly connected using a second channel in the 2.4 GHz band.

The configuration of the wireless system 1 according to the present embodiment is merely an example, and other configurations may be used. For example, although a case was illustrated in which each of the base station 10 and the terminal 20 has three STA functions (radio signal processing units), the present invention is not limited to this. The base station 10 need only include at least two radio signal processing units. Similarly, the terminal 20 need only include at least two radio signal processing units. Also, the number of channels that can be processed by each STA function can be set as appropriate according to the frequency band used. Each of the wireless communication modules 14 and 24 may support wireless communication in a plurality of frequency bands using a plurality of communication modules, or may support wireless communication in a plurality of frequency bands using a single communication module.

Here, processing of the MAC layer at the time of communication between the base station 10 and the terminal 20 will now be described with reference to FIG. 5. Processing of the MAC layer shown in FIG. 5 conforms to the IEEE 802.11 standard. FIG. 5 illustrates both transmission-side processing and reception-side processing. When the wireless module of one of the base station 10 and the terminal 20 performs transmission-side processing, the wireless module of the other performs reception-side processing. In the following example, the wireless modules of the transmission-side and reception-side will be described without being discriminated from each other.

Transmission-side processing will be described first. In step S10, the wireless module performs A-MSDU aggregation. Specifically, the wireless module concatenates multiple LLC packets input from the LLC layer to generate an aggregate-MAC service data unit (A-MSDU).

In step S11, the wireless module allocates a sequence number (SN) to the A-MSDU. The sequence number is a unique number for identifying the A-MSDU.

In step S12, the wireless module fragments (divides) the A-MSDU into multiple MAC protocol data units (MPDUs).

In step S13, the wireless module encrypts each MPDU to generate an encypted MPDU.

In step S14, the wireless module adds a MAC header and error detection code (FCS) to each encrypted MPDU. The error detection code is, for example, cyclic redundancy check (CRC) code.

In step S15, the wireless module performs A-MPDU aggregation. Specifically, the wireless module concatenates multiple MPDUs to generate an aggregate-MAC protocol data unit (A-MPDU) as a MAC frame. After step S15, the wireless module performs processing of the physical layer on the MAC frame.

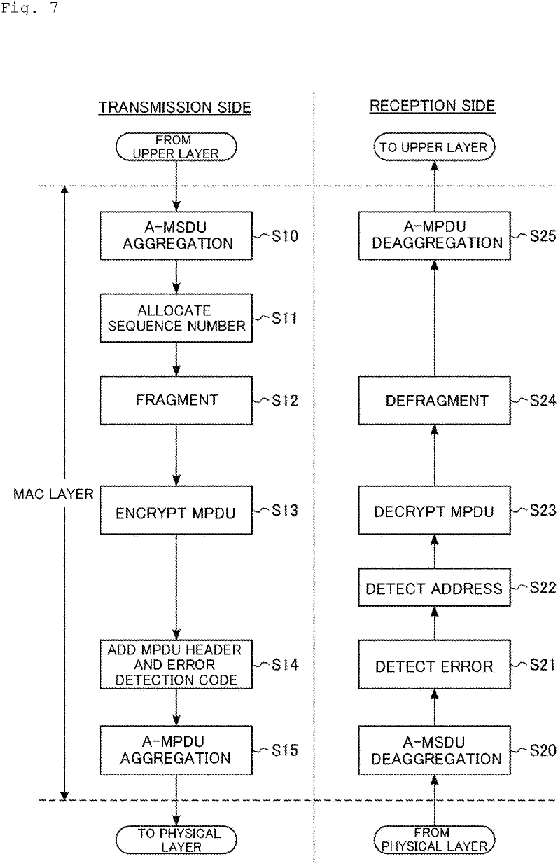

Next, reception-side processing will be described. When a radio signal is received, the wireless module performs processing of the PHY layer to acquire a MAC frame from the radio signal. Thereafter, the wireless module performs the MAC layer processing illustrated in FIG. 7.

In step S20, the wireless module performs A-MPDU deaggregation. Specifically, the wireless module divides the A-MPDU into units of MPDUs.

In step S21, the wireless module performs error detection. For example, the wireless module determines whether or not reception of the radio signal is successful according to CRC. If reception of the radio signal has failed, the wireless module may request retransmission. At this time, the wireless module may request the retransmission in units of MPDUs. On the other hand, if reception of the radio signal is successful, the wireless module performs next processing.

In step S22, the wireless module performs address detection. At this time, the wireless module determines whether or not MPDUs which have been sent thereto are addressed to thereto according to an address recorded in the MAC header of each MPDU. If the MPDUs are not addressed to the wireless module, the wireless module does not perform next processing. If the MPDUs are addressed to the wireless module, the wireless module performs next processing.

In step S23, the wireless module decrypts the encrypted MPDU.

In step S24, the wireless module defragments the MPDUs. In other words, the wireless module reconstructs the A-MSDU from a plurality of MPDUs.

In step S25, the wireless module performs A-MSDU deaggregation. Specifically, the wireless module reconstructs LLC packets in units of MSDUs from the A-MSDU.

After step S25, the wireless module outputs the LLC packets to the layer above the MAC layer. The higher layer is the LLC layer, for example.

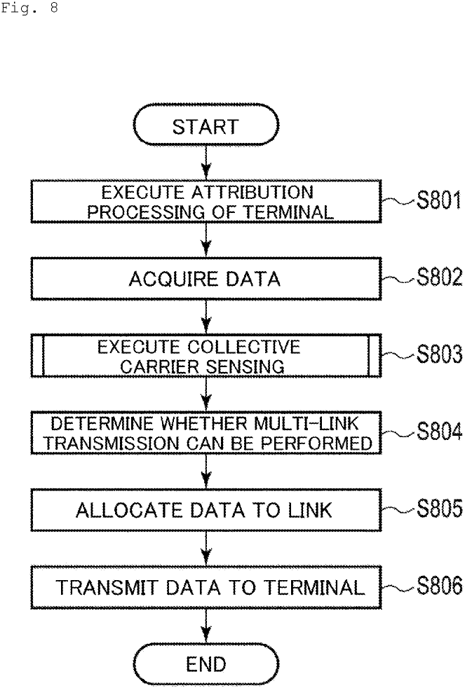

Next, an example of data transmission from the base station 10 to the terminal 20, that is, an operation of the base station 10 on downlink according to the present embodiment will be described with reference to the flowchart of FIG. 8.

In step S801, the link management unit 120 performs attribution processing of the terminal 20. In the present embodiment, capability regarding whether or not multi-link can be executed and operation parameters for multi-link operation are included and transmitted in a beacon from the base station 10 or a probe response for responding to a probe request from the terminal 20. In other words, it is assumed that the base station 10 and the terminal 20 perform attribution processing for which multi-link is desired from the beginning.

For example, the base station 10 and the terminal 20 can execute attribution processing for multi-link from the beginning by mutually notifying of the capability of multi-link, a link that is a multi-link target, and operation parameters in each link before association processing.

In step S802, the link management unit 120 acquires data (LLC packets) to be transmitted from the data processing unit 110.

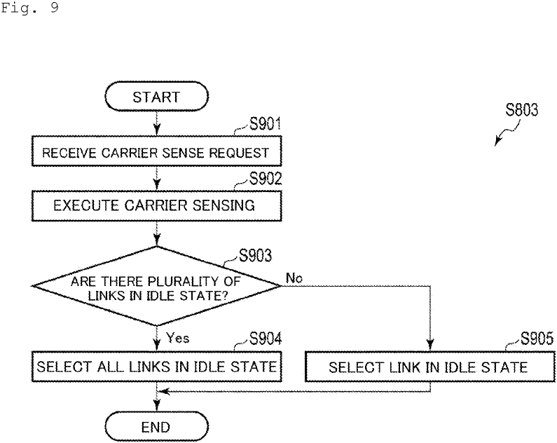

In step S803, the carrier sense control unit 160 executes collective carrier sensing using a common access parameter on each STA function, that is, each of radio signal processing units 130, 140, and 150. The carrier sense control unit 160 will be described in detail later with reference to FIG. 9.

In step S804, the link management unit 120 determines whether or not transmission can be performed by multi-link. Specifically, if a plurality of links are available after carrier sensing, it is determined that transmission can be performed by multi-link.

In step S805, the link management unit 120 allocates transmission data to links.

In step S806, the radio signal processing units corresponding to the links determined to be available in step S804 transmit data to the terminal 20 through the respective links.

Next, carrier sense control processing of the carrier sense control unit 160 of the base station 10 will be described with reference to FIG. 9. Although FIG. 9 shows the case of downlink, the carrier sense control unit 260 of the terminal 20 may perform the same processing as that of the carrier sense control unit 160 of the base station 10 shown in FIG. 9 in the case of uplink in which data is transmitted from the terminal 20 to the base station 10.

In step S901, the carrier sense control unit 160 receives a carrier sense request requesting execution of carrier sensing, for example, from the link management unit 120. Specifically, when the link management unit 120 receives data to be transmitted from the data processing unit 110, for example, it requests the carrier sense control unit 160 that the carrier sense control unit 160 execute carrier sensing.

In step S902, the carrier sense control unit 160 executes collective carrier sensing on each of the radio signal processing units 130, 140, and 150 using the common parameter in response to the carrier sense request. For example, the carrier sense control unit 160 obtains a carrier sense period by adding a random back-off period to an AIFS. The random back-off period is obtained by multiplying a unit slot time by a random number. Each of the radio signal processing units 130, 140, and 150 measures an RSSI of a channel by CCA and generates carrier sense information including a measurement value of the RSSI. The carrier sense control unit 160 receives carrier sense information from each of the radio signal processing units 130, 140, and 150, determines that the channel is in an idle state when the RSSI indicated by the carrier sense information is lower than a threshold value over the carrier sense period, and determines that the channel is a busy state otherwise. For convenience of description, a link of a radio signal processing unit having a channel determined to be in an idle state is also called a link in an idle state.

In step S903, the carrier sense control unit 160 determines whether or not there are a plurality of links determined to be in an idle state in step S902. If it is determined that there are a plurality of links in an idle state (Yes in step S903), processing proceeds to step S904. On the other hand, if it is determined that there is one link in an idle state (No in step S903), processing proceeds to step S905.

In step S904, the link management unit 120 selects all links in an idle state as links to be used for transmission on the basis of information on links in an idle state acquired from the carrier sense control unit 160. That is, links for performing cooperative transmission by multi-link are selected.

In step S905, the link management unit 120 selects one link in an idle state as a link to be used for transmission.

In the case of an access control method according to enhanced distributed channel access (EDCA), independent carrier sensing may be performed for each access category. Access categories may include, for example, AC_VO (Voice), AC_VI (Video), AC_BE (Best effort), and AC BK (Background). The carrier sense control unit 160 may set an independent carrier sense period for each access category and execute collective carrier sensing on the radio signal processing units 130, 140, and 150 for each access category. In the case of transmitting data after execution of carrier sensing, the data may be transmitted depending on access parameters set for each access category. The access parameters may include CWmax, CWmin, AIFS, and TXOPLimit. CWmax and CWmin are a maximum value and a minimum value of a contention window (CW), which is a time for waiting for transmission for contention avoidance. AIFS (Arbitration Inter Frame Space) is a frame transmission interval and indicates a fixed transmission waiting time set for each access category for collision avoidance control provided with a priority control function. TXOPLimit is an upper limit value of transmission opportunity (TXOP), which is a channel occupancy time.

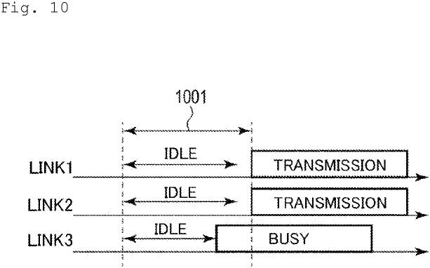

Next, an example of a link to be used for transmission, selected through carrier sense control processing shown in FIG. 9, will be described with reference to the conceptual diagram of FIG. 10.

FIG. 10 is a diagram showing states of each link in time series when data has been transmitted after carrier sensing.

Link 1 corresponds to a link formed by the radio signal processing unit 130, link 2 corresponds to a link formed by the radio signal processing unit 140, and link 3 corresponds to a link formed by the radio signal processing unit 150.

Through processing of step 902 shown in FIG. 9, it is determined whether each of link 1, link 2, and link 3 is in an idle state or a busy state in a carrier sense period 1001. In the example shown in FIG. 10, it is determined that link 1 and link 2 are in an idle state and link 3 is in a busy state when carrier sensing in the carrier sense period 1001 is completed.

Accordingly, the link management unit 120 selects link 1 and link 2 in an idle state as links to be used for transmission and transmits signals from the radio signal processing unit 130 and the radio signal processing unit 140 by multi-link.

Next, transmission data determination and allocation processing in the link management unit 120 will be described.

When the link management unit 120 has acquired data to be transmitted from the data processing unit 110, the link management unit 120 allocates the data to be transmitted to links in an idle state. For example, when a traffic type (TID) of data that can be transmitted is associated with each link, if a link associated with a TID of data is in an idle state, the data to be transmitted is allocated to the link. A traffic type is provided in units of applications (sessions) that the terminal 20 handles.

On the other hand, when links are not associated with TIDs, the link management unit 120 combines data to be transmitted in units of MSDUs regardless of types of TIDs and divides the combined data by the number of links in an idle state. The link management unit 120 allocates the divided data to each link in an idle state. Accordingly, the sizes of the data allocated to the links becomes uniform, and thus TXOP times can also become uniform.

Further, data to be transmitted may be allocated to each link in an idle state in units of MSDUs. In this case, since the TXOP times can also be different when the data sizes are different, the link management unit 120 sets a TXOP time set by a link having the longest TXOP time as the TXOP time of other links. Accordingly, the TXOP times can become uniform.

In addition, the link management unit 120 adds a common sequence number to data regardless of links in order to unify Block ACK from the terminal 20. That is, when the link management unit 120 allocates data obtained by combining data to be transmitted and then dividing the data to links, the link management unit 120 adds a multi-link flag indicating that the data has been transmitted by multi-link and a common sequence number to each piece of the divided data. In this case, for example, sequence numbers in the ascending order may be assigned.

Further, the link management unit 120 may add sequence numbers, for example, in the allocated order, regardless of links, even when the data is allocated to links in an idle state in units of MSDUs. The link management unit 120 outputs data, a sequence number, and a TXOP time allocated to each link to radio signal processing units for performing cooperative transmission by multi-link.

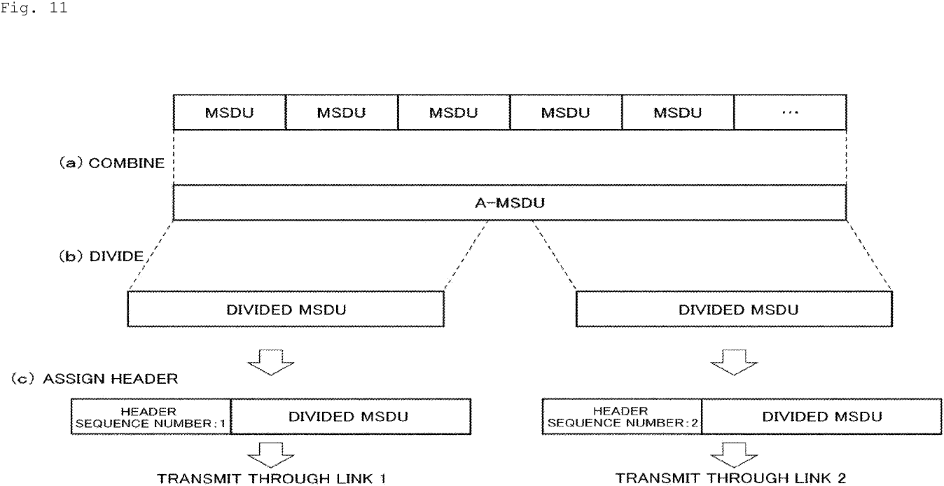

FIG. 11 shows an example of performing processing of combining data to be transmitted in units of MSDUs and then dividing the data as an example of allocation of transmission data to links through the link management unit.

In the example shown in FIG. 11, it is assumed that the base station 10 transmits data to the terminal 20 using link 1 and link 2 as a multi-link as shown in FIG. 10. The link management unit 120 generates an A-MSDU by combining MSDUs, and then divides the A-MSDU by the number of links to be used. In this case, since two links are used, the A-MSDU is divided into two, and the divided MSDUs are generated. It is also possible to divide the A-MSDU by a multiple of the number of links to be used.

Thereafter, a common sequence number is stored in the header of each divided MSDU regardless of links to which the divided MSDUs are allocated. Then, a MAC frame including a divided MSDU to which the header has been assigned is generated and transmitted through each link. For example, although a MAC frame including a divided MSDU to which a sequence number of “2” has been assigned has a sequence number of “1” in link 2 because it is first data in link 2, data is unified by assigning a sequence number common to the multi-link and thus it is possible to easily determine which data should be retransmitted when Block ACK is received from the terminal 20. The common sequence number may be added to each of the MSDUs. In this case, the transmission side combines the MSDUs to construct a data block corresponding to a divided MSDU and adjusts the length by padding as necessary. On the reception side, the MSDU is restored from each data block and rearranged on the basis of the common sequence number.

According to the above-described present embodiment, collective carrier sensing is performed on the STA function of each radio signal processing unit using a common parameter, and a link in an idle state is selected as a link to be used for data transmission. Accordingly, transmission start times of data transmission can be made uniform according to common CSMA/CA. Furthermore, by making TXOP times uniform between links used for data transmission, transmission end times between links can be made uniform. As a result, data transmission through a multi-link synchronized between links can be performed, and throughput can be improved.

At least a part of the above-mentioned processing may be realized by a processor executing a program (computer-executable instruction). The program may be provide to the base station 10 in a state stored on a computer-readable storage medium. In this case, for example, the base station 10 is further provided with a drive (not illustrated) for reading the data from the storage medium and acquires the program from the storage medium. Examples of the storage medium include a magnetic disk, an optical disk (CD-ROM, CD-R, DVD-ROM, DVD-R, and the like), a magneto-optical disk (MO and the like), and a semiconductor memory. Further, the program may be stored in a server of a network, and the base station 10 may download the program from the server.

Meanwhile, the present invention is not limited to the above embodiments, and can be modified in various ways without departing from the scope thereof at the implementation stage. In addition, embodiments may be combined as appropriate, and in such a case, combined effects can be achieved. Furthermore, the foregoing embodiments include various inventions, and various inventions can be extracted by selecting combinations of the multiple constituent elements disclosed herein. For example, even if several of the constituent elements described in the embodiments are removed, a configuration in which those constituent elements have been removed can be extracted as an invention as long as the problem can be solved and the effect can be achieved.

[Reference Signs List]

| | |
|---|---|
| 1 | Wireless system |
| 10 | Base station |
| 11, 21 | Processor |
| 12, 22 | ROM |
| 13, 23 | RAM |
| 14, 23 | Wireless module |
| 15 | Wired module |
| 16, 27 | Antenna |
| 20 | Terminal |
| 25 | Display |
| 26 | Storage |
| 30 | Server |
| 41 | MAC frame processing unit |
| 42 | PHY processing unit |
| 43 | Error detection unit |
| 110, 210 | Data processing unit |
| 120, 220 | Link management unit |
| 121, 221 | Link management information |
| 122, 222 | Association processing unit |
| 123, 223 | Authentication processing unit |
| 130, 140, 150, 230 240, 250 | Radio signal processing unit |
| 160, 260 | Carrier sense control unit |
| 270 | Application execution unit |
| 1001 | Carrier sense period |

1. A base station comprising:
a plurality of radio signal processing units that transmit and receive radio signals of different channels;
a carrier sense control unit that executes collective carrier sensing on a channel of each of the plurality of radio signal processing units using an access parameter common to the plurality of radio signal processing units and determines whether the channel is in an idle state or a busy state; and
a management unit that performs processing for transmitting radio signals by a multi-link wirelessly connected through a plurality of types of channels when there are a plurality of links formed between a radio signal processing unit having the channel determined to be in an idle state and a terminal.

2. The base station according to claim 1, wherein the management unit combines a plurality of pieces of data to be transmitted by the multi-link, divides the combined transmission data by number of links to be used by the multi-link, and allocates the divided data.

3. The base station according to claim 1, wherein the management unit allocates a plurality of pieces of data to be transmitted by the multi-link to links to be used by the multi-link according to a traffic type of data.

4. The base station according to claim 3, wherein the management unit sets a longest TXOP time among TXOP times of links used in the multi-link as a TXOP time of other links used in the multi-link.

5. The base station according to claim 1, wherein the management unit allocates a sequence number common to the multi-link to a plurality of pieces of data to be transmitted through the multi-link.

6. A communication method comprising: performing collective carrier sensing on a channel of each of a plurality of radio signal processing units that transmit and receive radio signals of different channels using an access parameter common to the plurality of radio signal processing units for the plurality of radio signal processing units;
determining whether the channel is in an idle state or a busy state as a result of the carrier sensing; and
performing processing for transmitting radio signals by a multi-link wirelessly connected through a plurality of types of channels when there are a plurality of links formed between a radio signal processing unit having the channel determined to be in an idle state and a terminal.
